(19) United States
(12) Patent Application Publication
(10) Pub. No.: US 2009/0182675 A1
(43) Pub. Date: Jul. 16, 2009

(54) METHOD AND SYSTEM FOR CONDUCTING ELECTRONIC COMMERCE OVER A NETWORK USING A SHADOW CREDIT CARD NUMBER

(76) Inventor: EDWARD BRODY, Washington, DC (US)

Correspondence Address: DLA PIPER LLP US, P. O. BOX 2758, RESTON, VA, 20195, US

(21) Appl. No.: 12/342,683

(22) Filed: Dec. 23, 2008

Related U.S. Application Data
(60) Provisional application No. 61/018,969, filed on Jan. 4, 2008.

(51) Int. Cl. G06Q 20/00; G06Q 30/00

(52) U.S. Cl. 705/72; 705/39; 705/74; 705/80

(57) ABSTRACT

A method and system are disclosed for conducting electronic commerce over a computer network. A first processor can be configured to receive first data including information of a buyer, and generate second data based on the first data. The first processor sends the second data to the second processor and the second processor processes the second data which causes a product and/or service to be provided to the buyer. The second processor does not receive first data.

### CROSS-REFERENCE TO RELATED APPLICATION

This application is based on and derives the benefit of the filing date of U.S. Provisional Patent Application No. 61/018,969, filed Jan. 4, 2008. The entire content of this application is herein incorporated by reference in its entirety.

### FIELD OF THE INVENTION

The present invention relates to a method and system of conducting electronic commerce over a computer network by permitting a host server to provide a supplier with a commercial instrument containing data of an end user, and wherein such commercial instrument is prohibited from containing certain confidential information of the end user.

### BRIEF DESCRIPTION OF THE DRAWINGS

Reference is made to the attached drawings, wherein elements having the same reference designations represent like elements throughout and wherein:

FIG. 1 illustrates a block diagram of a system that permits a host server to issue a shadow credit card number in order to facilitate a business transaction according to an embodiment of the present invention.

FIG. 2 illustrates a block diagram of a system utilized by the host that uses a shadow credit card number to enable billing according to an embodiment of the present invention.

FIG. 3 illustrates in flow diagram form the steps undertaken by the system to enable a user to initiate a charge in an embodiment of the present invention.

FIG. 4 illustrates in flow diagram form the steps undertaken by the system to enable billing in an embodiment of the present invention.

### DETAILED DESCRIPTION OF SEVERAL EMBODIMENTS

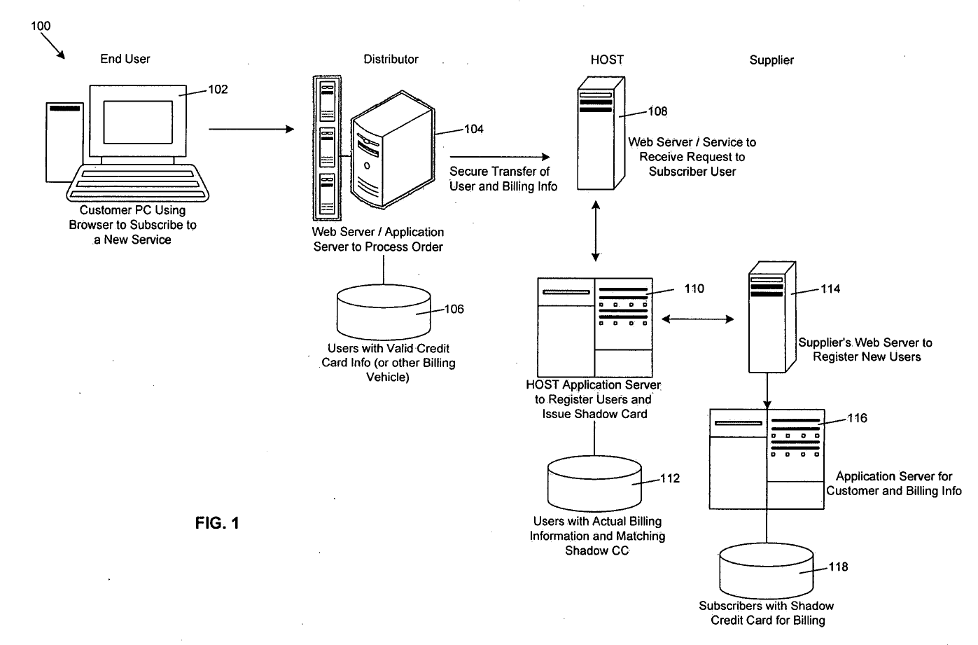

FIG. 1 illustrates an embodiment of a system 100 that allows a host server 110 to issue a “shadow credit card” number corresponding to a user. The host server can include separate servers 108, 110. However, a single host server 110 may be configured to execute the functionalities required by the host. The shadow credit card number enables the supplier's server 114, 116 to charge an end user for products and/or services of the supplier which the end user may have purchased. Such an end user can be registered with a distributor. The distributor can provide an environment on server 104 that enables the end user to purchase the products and/or services of the supplier on server 114. Of course, the end user can also be registered with the host server 110, that may then provide an environment that permits the end user to purchase the goods and services. As used herein, the term “shadow credit card” number refers to a card number which stands in as a substitute to a regular credit card number, and can be used by the host server 110 to complete a business transaction with a supplier. It is to be understood that transactions executed by entities such as end user, distributor, host and supplier can be accomplished via computers/servers associated with these entities. For example, end user computer 102 can execute tasks associated with the end user, web server/application server 104 can execute tasks associated with the distributor, host servers 108, 110 can execute tasks associated with the host, and supplier servers 114, 116 can execute tasks associated with the supplier.

The end user may subscribe to a new service associated with a distributor's server 104 via his/her personal computer 102. Distributor can be, for example, an Internet service provider (ISP) in which the end user may be a registered member. The end user may register through computer 102 with the distributor server 104 by using, for example, a valid credit card number or other billing vehicle to ensure regular payment of periodic services provided by the distributor. The distributor server 104 can then store the end user's credit card or other billing information in a database 106. Such a database 106 can also contain information relating to other registered users. Therefore, a user can complete a regular credit card purchase by accessing a product of a supplier which may be featured on the distributor's website or on the website of supplier on server 114.

The host and distributor can form a business relationship in order to efficiently make available to an end user the products and services of a supplier. Such relationship can include the distributor providing the host with legal access to information relating to the end user and/or information stored in the database 106 relating to registered users of the distributor. This relationship may entail a secure transfer of the end user's credit card information to the host server 110. Therefore, data such as the name, address, billing information, credit card number, etc. of the end user may be transferred by the distributor server 104 to the secured host server 110. The host server 110 may also receive a request from the distributor server 104 to subscribe the end user. When the request is processed, the end user may be registered as a user/subscriber within the host server 110. Such registered users may then be assigned a shadow card number having information associated with it that differs from information of the registered user's original credit card as registered with the distributor server 104. The shadow card number may be configured to correspond to billing information that is sufficient for a supplier to bill the end user. The shadow credit card number is prohibited from containing certain confidential information of the end user's original credit card. The host server 110 may assign a shadow card number to an end user from an available pool of shadow credit card numbers. There can be one shadow card number per instance of a user account and supplier. That is, a shadow card number may be assigned on a subscription basis wherein a unique shadow card number is generated for each subscription. Alternatively, a shadow card number may be assigned based on a user-supplier combination, wherein a shadow card number can be assigned to the end user based on his/her subscriptions with a specific supplier 114. Alternatively a shadow credit card number can be issued to a user for all of his/her transactions. As another alternative, a new shadow credit card number can be issued for each transaction of the user. After the shadow card number is generated and assigned to the end user, that information relating to the shadow card number can be stored in a database 112.

The host server 110 can communicate with a supplier server 114 in order to register the end user wherein information associated with the shadow card number may form the basis for such registration and/or billing of the end user. The host server 110 can then transfer the shadow card number to the supplier server 114 which is then expected to securely store the shadow card number as they would a regular credit card number. An application server 116 of the supplier may be assigned to process the end user's registration and/or billing information. Of course, the supplier may use a different processor to process such registration and/or billing information. The supplier may then store the end user's registration and/or billing information in database 118.

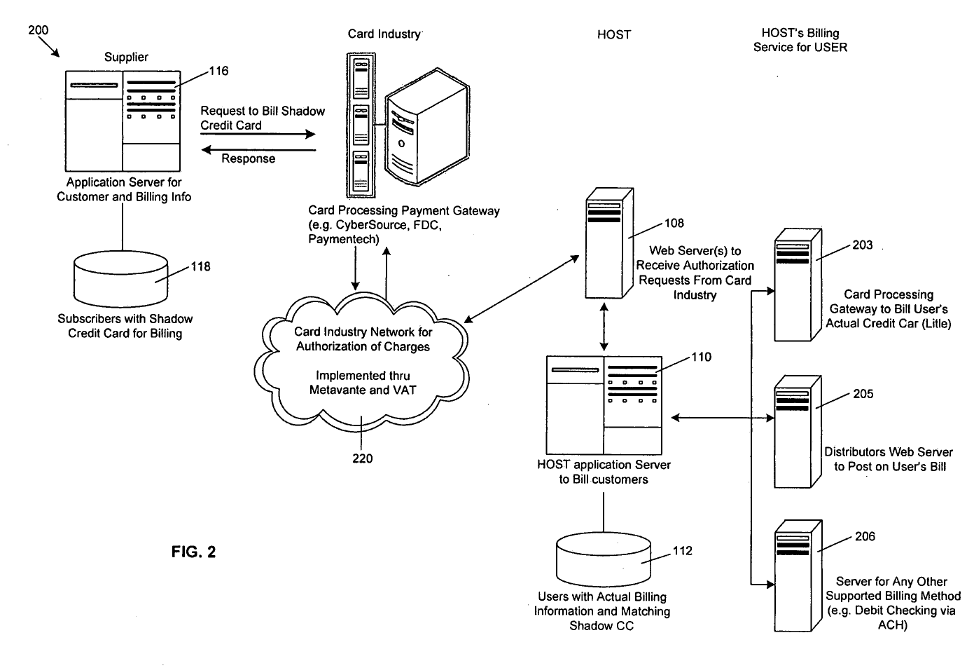

FIG. 2 illustrates a block diagram of a system utilized by the host server 110 that uses a shadow credit card number to enable billing according to an embodiment of the present invention. The billing can occur over a network 220. A supplier may reach an event at which an end user is to be billed for a product or service provided by the supplier. An application server 116 associated with the supplier may be assigned to process the end user's registration and/or billing information. The processed information can be stored in a database 118. The application server 116 can determine an amount to bill the end user, prior to sending the such determined amount to the card industry 204. The application server 116 can then request to bill a shadow credit card number as a standard process in order to achieve its requested payment. That is, the supplier's application server 116 may issue a request to the card industry 204 (e.g., Discover, Visa, MasterCard) over a network to bill the shadow card number which corresponds to products and services of the supplier purchased by the end user. The card industry 204 serves as a card processing gateway for facilitating payments on behalf of the supplier. Such card processing gateway can include entities configured to validate and authenticate each transaction. The card industry network 220 implements the rules for processing and authorizing transactions for payment and may send such authorization request to the host server 108. When the host server 108 receives an authorization request from the card industry 220, the host server 108 can then determine whether such authorization request is valid. The host application server 110 communicates with the host server 108 to determine if an authorization request is valid. If valid, the application server 110 retrieves the end user's billing method and information, and then employs such billing method and information to obtain payment from the user. This may entail a card processing gateway server 203 that enables the host application server 110 to bill the end user's actual credit card. The billing method may also include permitting the host application server 110 to access a distributor's web server 205 to post the charge to the end user's bill from the distributor; or the billing method may include permitting the host application server 110 access to any other server 206 that supports an end user's billing method that may include, for example, debit checking, electronic checks etc. The host application server 110 can store the end user's actual billing information in database 112. Database 112 can then be used to obtain the actual billing information based on a corresponding shadow credit card number that may be matched with the end user's actual billing method, such as their credit card number.

The host server 108 can make a determination as to whether to authorize a request received from the card industry 204 based on results obtained from matching a given shadow credit card number with the end user's actual billing method, such as their credit card number. For example, as the host server 108 authorizes a request from the card industry 204, the host application server 110 can determine the end user's actual credit card number from database 112, and then send the real credit card number through the system via gateway 203. An approval response can be sent by the card industry to the supplier's application server 116 when the host server 108 approves the authorization of charges. Similarly, a declined response can be sent to the supplier's application server 116 when the host server 108 declines the authorization of charges such as when the credit card number received from the supplier's application server 116 does not match any issued shadow credit card number. The supplier 116 can then access the approved or declined response, and then follow a given procedure for handling such responses.

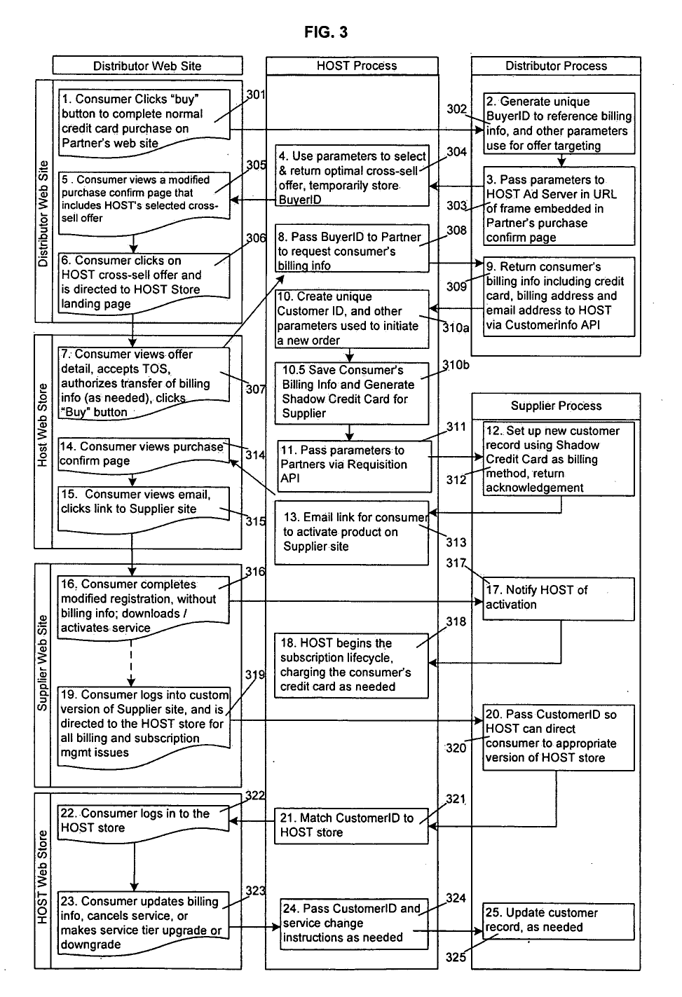

FIG. 3 illustrates in flow diagram form the steps undertaken by the system to enable a user to initiate a charge in an embodiment of the present invention. In operation 301, a user/consumer can access a product or service of a supplier from within a distributor's website. The consumer may be registered as a member with the distributor. The consumer can access a supplier's product or service via a “buy” button which may be located within the distributor's website. In operation 302, the distributor may generate a unique buyerID that references the billing information of the consumer when such a consumer accesses a product or service of a supplier. The distributor may also generate other parameters based on the buying habits of the consumer. Such parameters can then be used to target other offers of products and services to the consumer. Such products and services can originate from multiple suppliers. In operation 303, the distributor can send the parameters and the generated unique buyerID to the host server for processing. The consumer can be capable of viewing a confirmation page that may be displayed on the distributor's website.

In operation 304, the host server may store the buyerID, and use the received parameters as a basis to select and return optimal cross-sell offers. The consumer can then view a modified purchase confirmation webpage that includes the cross-sell offer from the host server, in operation 305. If the consumer accesses the host's cross-sell offer in order to determine the details of the cross-sell offer, the consumer is directed to the store landing webpage of the host, in operation 306. In operation 307, the consumer can view the details of the cross-sell offer, accept the terms of service, authorize a transfer of billing information, and/or accept the offer by accessing, for example, the “buy” button located on a webpage of the host. In operation 308, the host server may be capable of sending the consumer's buyerID to the distributor requesting the consumer's billing information. Of course, the system need not include the cross-sell opportunities that are described in operations 303 through 308. If operations 303-308 are bypassed, the distributor can return or send the consumer's billing information to the host server (operation 309) after generating a user/consumer unique buyerID that references the user's billing information (operation 302). However, if operations 302-308 are executed, in response to the request from the host server (operation 308), the distributor can return or send the consumer's billing information to the host server, in operation 309. Such billing information can include the consumer's actual credit card information, billing address, and email address. The host server can then create a unique customerID and other parameters that can be used to initiate a new order, in operation 310(a). In operation 310(b), the host server can store the customer's billing information, and generate a shadow credit card number for the supplier based on the consumer's billing information. In operation 311, the host server can pass the parameters and unique customerID to the supplier's server/processor. This enables the supplier to set up a new customer record that uses the shadow credit card number as a billing method, in operation 312. The supplier's server can also be configured to return an acknowledgement response to the host server when it receives the shadow credit card information. When such an acknowledgment response is received by the host server, the host server can create an email link associated with the product/service, in operation 313. The host server can also display a confirmation page that enables the consumer to view purchases he/she made, in operation 314. The consumer can then activate or gain access to the supplier's website by viewing and then accessing the email link, in operation 315. By accessing of the email link the consumer is channeled to the supplier's website, wherein the consumer can complete a modified registration process that may not include the consumer's billing information, in operation 316. The consumer can also download any tools required by the supplier so as to activate service.

In operation 319, such service activation may require the consumer to log onto a customized version of a transaction web page displayed by the supplier so that the consumer is directed to the host server for all the required billing and management issues. The supplier may also notify the host of the consumer's service activation, in operation 317. When the host server receives such notification, the host can proceed to initiate a subscription lifecycle by charging the consumer's credit as the need arises, in operation 318. Moreover, in operation 319, the customer can be directed to the host's website for all billing and subscription issues. If necessary, the consumer can log in to the host website, in operation 322. In an embodiment of the present invention, after the consumer is informed to direct billing and subscription issues of the host website, the supplier may pass the consumer's customerID to the host server so that the host server can direct the consumer to an updated or appropriate version of the host website, in operation 320. This may entail the host server matching the consumer's customerID to a corresponding webpage or location within the host website, in operation 321. When a match is determined, the consumer can then log in to the host website, in operation 322.

In operation 323, after the consumer has successfully logged in to the host website, the consumer can then update his/her billing information, cancel service, and/or upgrade or downgrade their service tier. In operation 324, the host web server may process the consumer's customerID and service change instruction, based on the consumer's update, service cancellation, service tier upgrade or downgrade. Such consumer updates can also be carried out within the supplier's server, in operation 325.

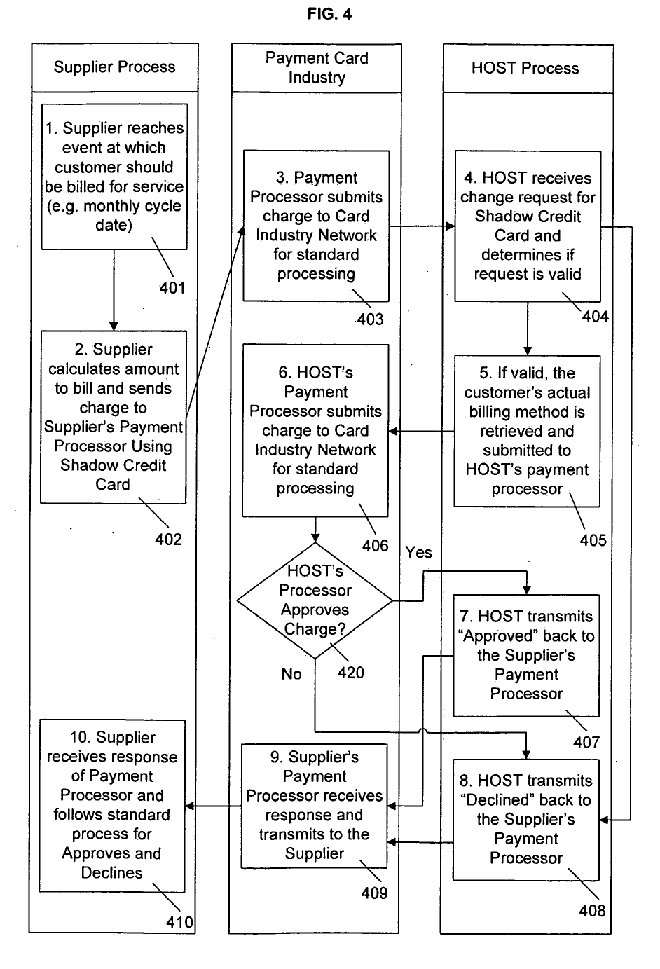

FIG. 4 illustrates in flow diagram form the steps undertaken by the system to enable billing in an embodiment of the present invention. In operation 401, a supplier can reach an event at which a customer/end user is to be billed for a product or service previously provided by the supplier. Such billing information may occur periodically such as on a monthly cycle date. An application server associated with a supplier may be assigned to process the end user's registration and/or billing information. In operation 402, the supplier's application server may calculate an amount to bill the end user, and sends the calculated amount to the card industry along with the shadow credit card number for the user. The shadow credit card number is used for standard processing of the end user's transactions, in operation 403. That is, the supplier's application server 116 (in FIG. 2) can issue a request to a card industry (e.g., Discover, Visa, MasterCard) to bill the shadow card number which corresponds to products and services of the supplier purchased by the end user. The card industry may serve as a card processing gateway for facilitating payments on behalf of the supplier. Such card processing gateways can include entities configured to validate and authenticate each transaction. The card industry network implements the rules for processing and authorizing transactions for payment and may send such authorization requests for the charges to the host server.

In operation 404, when the host server receives the authorization requests from the card industry, the host server can determine whether such authorization requests are valid. If valid, the host server may retrieve and process the end user's billing method and information, in operation 405. Thereafter, a charge resulting from the host server's processing of the end user's billing information can be submitted to the card industry for processing, in operation 406. In operation 420, the host's credit card processor can determine whether to approve the charge. If the host server approves the charge, an approval response can be sent to the supplier's application server so that payment can be processed, in operation 407.

If the host credit card processor declines the charge or if the host determines a charge based on a shadow credit card number is not valid, a declined response may be sent to the supplier's application server, in operation 408. In operation 409, the application server of the supplier receives either of the approved or declined response. The approved or declined response helps direct the supplier in following specified procedures thereafter, in operation 410. Such response can require the supplier to then mail a product to the end user, or may require the supplier to email or fax a link which may enable a user to access certain product or service information.

While the present invention has been described in connection with the illustrated embodiments, it will be appreciated and understood that modifications may be made without departing from the spirit and scope of the invention.

What is claimed is:

1. A system for conducting electronic commerce over a computer network, comprising:
a first processor configured to:
receive first data including information of a buyer, and
associate second data corresponding to the first data; and
a second processor, wherein the first processor sends the second data to the second processor and the second processor processes the second data which causes a product and/or service to be provided to the buyer, wherein the second processor does not receive at least some of the first data.

2. The system of claim 1, further comprising a service provider processor associated with a service provider with which the buyer is registered.

3. The system of claim 1, wherein the second processor is associated with a supplier of the product and/or service.

4. The system of claim 1, wherein the first data includes at least a portion disposed on a credit card.

5. The system of claim 4, wherein the first data includes at least one of name, address, mailing information, and/or original credit card unique identification number of the buyer.

6. The system of claim 1, wherein the second data includes a surrogate credit card number, the second data not including an original credit card unique identification number of the buyer.

7. The system of claim 2, wherein the service provider processor generates a unique buyer ID that references billing information of the buyer.

8. The system of claim 7, wherein the unique buyer ID references data used to target offers of products and/or services to the buyer.

9. The system of claim 1, wherein:
the second processor sends the second data to the first processor, said first processor using the first data to charge the buyer in response to the second data.

10. A method of conducting electronic commerce over a computer network, comprising:
receiving first data via the computer network, the first data including information of a buyer;
associating second data corresponding to the first data in a processor; and
sending the second data to a seller over the network, wherein the second data serves as a basis to provide a product or service to the buyer, said seller not receiving at least some of said first data.

11. The method of claim 10, wherein the first data includes at least a portion disposed on a credit card.

12. The method of claim 11, wherein the first data includes at least one of name, address, mailing information, and/or original credit card unique identification number of the buyer.

13. The method of claim 10, wherein the second data includes a surrogate credit card number, the second data not including the information of the buyer as contained in the first data.

14. The method of claim 10, further comprising:
receiving a unique buyer ID that references billing information of the buyer.

15. The method of claim 14, wherein the unique buyer ID references data used to target offers of products and/or services to the buyer.

16. The method of claim 10, further comprising:
receiving the second data from the seller to cause the first data to be used as basis to charge the buyer.

17. A system for conducting electronic commerce over a communication network, comprising:
a first server platform configured to allow a user to select at least one provider to engage in a business transaction, the first server platform receiving confidential information associated with the user;
a second server platform accessing the confidential information of the user located within the first server platform in order to create a commercial instrument;
a third server platform connected to the second server platform, the third server platform configured to receive the content of the commercial instrument which is used to process a financial charge attributed to the user based on the business transaction, and
wherein the commercial instrument does not contain at least some of the confidential information of the user, and wherein the commercial instrument serves as the basis for the seller to deliver a product and/or service to the user.

18. The system of claim 17, wherein the first server platform is associated with a service provider with which the user is registered.

19. The system of claim 17, wherein the second server platform is associated with a source of the commercial instrument.

20. The system of claim 17, wherein the third server platform is associated with the provider.

21. The system of claim 17, wherein the confidential information comprises a unique identification number associated with a credit card of the user.

22. The system of claim 17, wherein the commercial instrument includes a surrogate credit card number and data associated with the user, the data being prohibited from including the user confidential information.

23. The system of claim 17, wherein the first server platform generates a unique buyer ID that references billing information of the buyer.

24. The system of claim 23, wherein the unique buyer ID is used to target offers of products and/or services to the buyer.

25. The system of claim 17, wherein the third server platform causes information associated with the commercial instrument to be sent to the second server platform to cause the user to be charged based on the confidential information.

26. A method for conducting electronic commerce over a communication network, comprising:
accessing, via the computer network, confidential information of a user which is located within a first server platform in order to create a commercial instrument;
sending the commercial instrument to a second server platform that processes a financial charge attributed to the user based on a business transaction conducted by the user on the first server platform, and
wherein the commercial instrument does not contain at least some of the confidential information of the user, and wherein the commercial instrument serves as a basis for the seller to provide a product and/or service to the user.

27. A method of electronic commerce over a computer network, comprising:
presenting, by a buyer, to an anonymous transaction server a first financial instrument issued by a first issuer to purchase an on-line item;
presenting, by said anonymous transaction server, to a seller of said on-line item a second financial instrument issued by a second issuer different from said first issuer; and
accepting, by said seller, said second financial instrument as a payment for said on-line item.

28. The method of claim 27, wherein the first financial instrument includes information disposed on a credit card.

29. The method of claim 28, wherein the first financial instrument includes at least one of name, address, mailing information, and/or original credit card unique identification number of the buyer.

30. The method of claim 27, wherein the second financial instrument includes a surrogate credit card number, the second financial instrument not including at least some of the information of the buyer as contained in the first financial instrument.

31. The method of claim 27, further comprising:
receiving a unique buyer ID that references billing information of the buyer.

32. The method of claim 31, wherein the unique buyer ID references data used to target offers of products and/or services to the buyer.

33. The method of claim 27, further comprising:
receiving the second financial instrument from the seller to cause the first financial instrument to be used as basis to charge the buyer.
